(19) United States
(12) Patent Application Publication
(10) Pub. No.: US 2007/0117598 A1
(43) Pub. Date: May 24, 2007

(54) BATTERY COVER LATCHING ASSEMBLY FOR PORTABLE ELECTRONIC DEVICE

(75) Inventors: Qing Yang, Shenzhen (CN); Chia-Hua Chen, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,. LT, Shenzhen (CN); SUTECH TRADING LIMITED, Tortola (VG)

(21) Appl. No.: 11/309,618

(22) Filed: Sep. 1, 2006

(30) Foreign Application Priority Data
Nov. 18, 2005 (TW) 94140591

(51) Int. Cl. G03B 17/04; H04M 1/00

(52) U.S. Cl. 455/575.1; 455/575.8; 396/347

(57) ABSTRACT

A portable electronic device (80) has a battery cover (100) and a housing (200) releasably mounted with a battery cover latching assembly (300). The battery cover has a positioning member (14). The housing has a knob hole (26). The battery cover latching assembly includes a knob (40) and a screw rod (64). The knob is rotatably received in the knob hole. The knob has a latching member (44). The screw rod is formed on the housing. The knob threadingly engages with the screw rod and the latching member releasably engages with the positioning member thereby releasably mounting the battery cover to the housing.

### DESCRIPTION

1. Field of the Invention

The present invention relates to battery cover latching assemblies and, more particularly, to a battery cover latching assembly for use in a portable electronic device.

2. Description of Related Art

Batteries are widely used in portable electronic devices, such as personal digital assistants (PDAs), mobile phones, and the like. Conventional batteries are attachably received in housings of the electronic device, and battery covers are designed to connect with the housings to package the batteries. The batteries have to be replaced by opening the battery covers when the batteries are damaged, dead, and/or otherwise in need of recharging or replacement.

A clasping structure or latching structure is used to engage a conventional battery cover with a housing of a portable electronic device. A conventional mobile phone has a latching assembly for a battery cover. The latching assembly includes two hooks at one end of the battery cover and a locking pin protruding from the other end of the battery cover. Two grooves are defined in one end portion of a backside of a housing of the mobile phone, and a locking hole is defined in the other end portion of the backside of the housing. In assembly, the hooks are firstly inserted into the grooves in the backside of the housing. Then, the battery cover is pressed downwards onto the housing until the locking pin on the battery cover is inserted into the locking hole in the backside of the housing. The battery cover is thus assembled to the housing of the mobile phone. The latching assembly is simple in structure, and the engagement between the battery cover and the housing of the mobile phone is firm too. However, during disassembly, great effort is needed to remove the battery cover, thereby requiring a relatively substantial force to be exerted thereon. Therefore, the battery cover can be susceptible to damage. As a result, it can be difficult for a user to replace a battery in the conventional housing of the mobile phone.

Therefore, a new battery cover latching assembly is desired in order to overcome the above-described shortcomings.

### SUMMARY OF THE INVENTION

In one embodiment thereof, a portable electronic device has a battery cover, a battery cover latching assembly, and a housing. The battery cover and the housing are connected via the battery cover latching assembly. The battery cover has a positioning member. The housing has a knob hole. The battery cover latching assembly includes a knob and a screw rod. The knob is rotatably received in the knob hole. The knob has a latching member. The screw rod is formed on the housing. The knob threadingly engages with the screw rod and the latching member releasably engages with the positioning member thereby allowing the battery cover to be releasably mounted to the housing.

Other advantages and novel features of the embodiments will become more apparent from the following detailed description thereof, when taken in conjunction with the accompanying drawings.

### BRIEF DESCRIPTION OF THE DRAWINGS

Many aspects of the battery cover latching assembly can be better understood with reference to the following drawings. The components in the drawings are not necessarily drawn to scale, the emphasis instead being placed upon clearly illustrating the principles of the present battery cover latching assembly and its potential applications. Moreover, in the drawings, like reference numerals designate corresponding parts throughout the several views.

FIG. 1 is an exploded, isometric view of a portable electronic device with a battery cover and a housing connected via a battery cover latching assembly, in accordance with a preferred embodiment;

FIG. 2 is similar to FIG. 1, but viewed from another aspect;

FIG. 3 is an enlarged, isometric view of the battery cover shown in FIG. 1;

FIG. 4 is an enlarged, partially cut-away view of the housing shown in FIG. 1, and viewed from another aspect;

FIG. 5 is an enlarged, assembled, partially cut-away view of the battery cover latching assembly shown in FIG. 1;

FIG. 6 is an assembled, isometric view of the battery cover latching assembly and the housing shown in FIG. 1;

FIG. 7 is an assembled, isometric of the portable electronic device shown in FIG. 1; and

FIG. 8 is an enlarged, partially cut-away view of the portable electronic device along line VII-VII shown in FIG. 7.

### DETAILED DESCRIPTION OF THE EMBODIMENTS

The present battery cover latching assembly is suitable for portable electronic devices, such as mobile phones, PDAs, and the like.

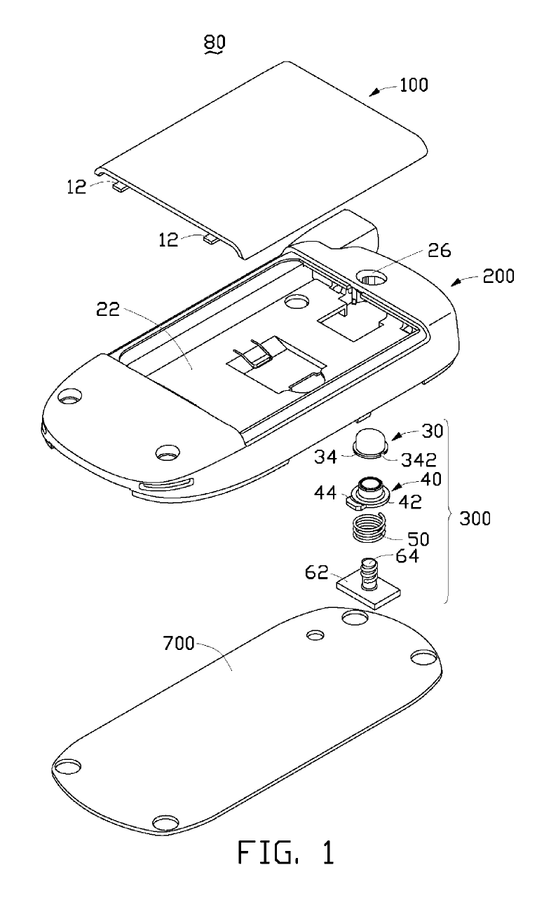

Referring now to the drawings in detail, FIG. 1 shows a battery cover latching assembly 300 for use in a mobile phone 80. The mobile phone 80 is taken here as an exemplary application, for the purposes of describing details of the battery cover latching assembly 300 of a preferred embodiment of the present assembly. The mobile phone 80 includes a housing 200 and a battery cover 100, connected via the battery cover latching assembly 300. A circuit board 700 is received in the housing 200. The housing 200 defines a knob hole 26 therein. The battery cover latching assembly 300 is mounted in the knob hole 26 of the housing 200 and releasably locks the battery cover 100, thereby interconnecting the housing 200 and the battery cover 100.

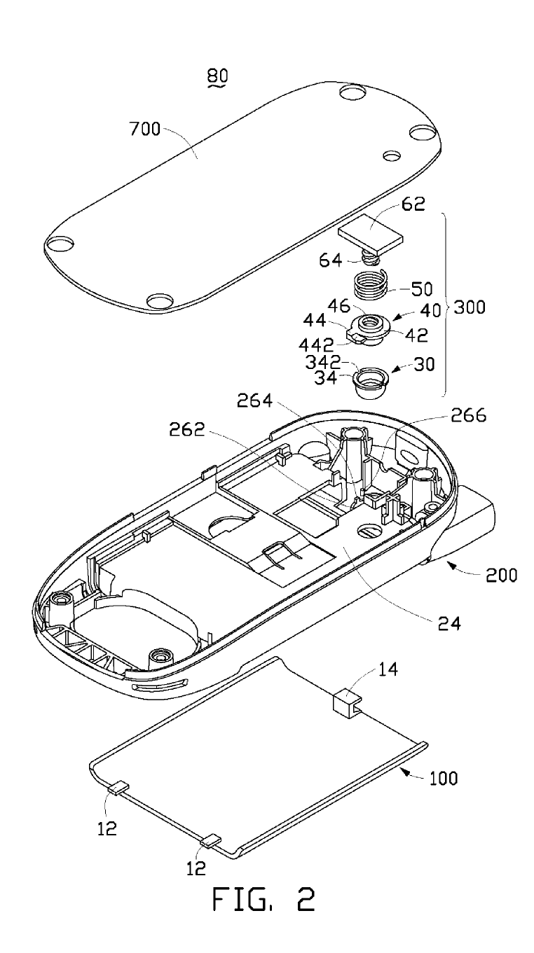

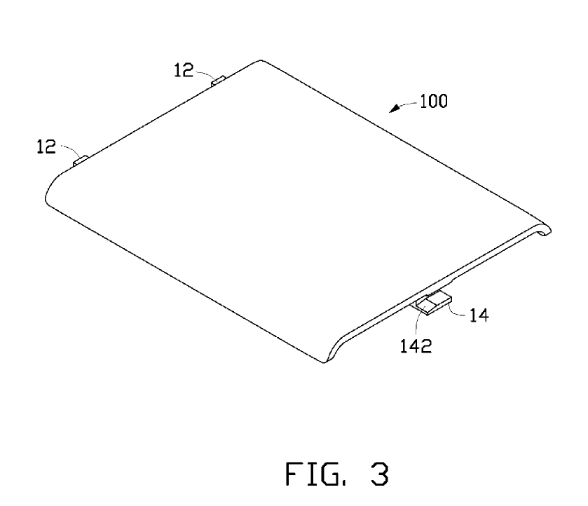

Also referring to FIGS. 2-3, the battery cover 1 00 is a substantially rectangular board. Two opposing sidewalls extend from a periphery of the body and towards a same direction. Two positioning tabs 12 are formed at one end of the battery cover 100. A positioning member 14 is formed at the other opposite end of the battery cover 100. The positioning member 14 is substantially C-shaped. An opening of the positioning member 14 faces away from the positioning tabs 12. A distal end of the positioning member 14 has a first wedge-shaped surface 142.

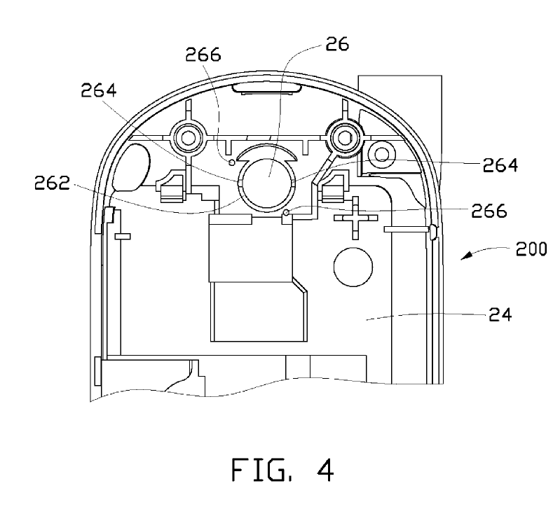

Also referring to FIG. 4, the housing 200 has a substantially rectangular body. The housing 200 defines a battery cavity 22 and a receiving cavity 24 in two opposing sides thereof. The battery cavity 22 is configured (i.e., structured and arranged) for receiving a battery (not shown) therein. The receiving cavity 24 is configured for receiving the circuit board 700 therein. Two positioning holes are defined in a bottom end portion. The positioning holes communicate with the battery cavity 22 and are configured for receiving the positioning tabs 12 of the battery cover 100. A knob hole 26 is defined in an opposing top end portion of the housing 200. The knob hole 26 communicates with the battery cavity 22 and the receiving cavity 24. A circular protrusion 262 extends around the knob hole 26 and in the receiving cavity 24. Two projections 264 extend from one end of the circular protrusion 262. The projections 264 are separated from each other by an angle of about 180 degrees. Two limiting poles 266 are formed on the housing 200 near the circular protrusion 262 in the receiving cavity 24.

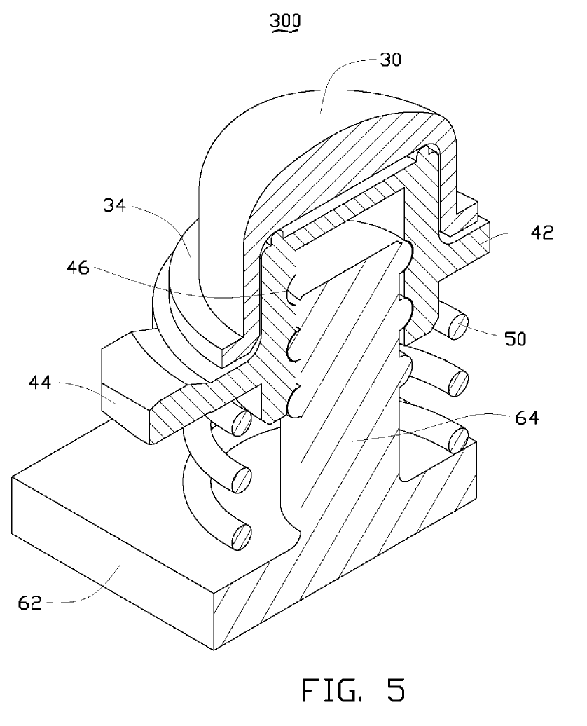

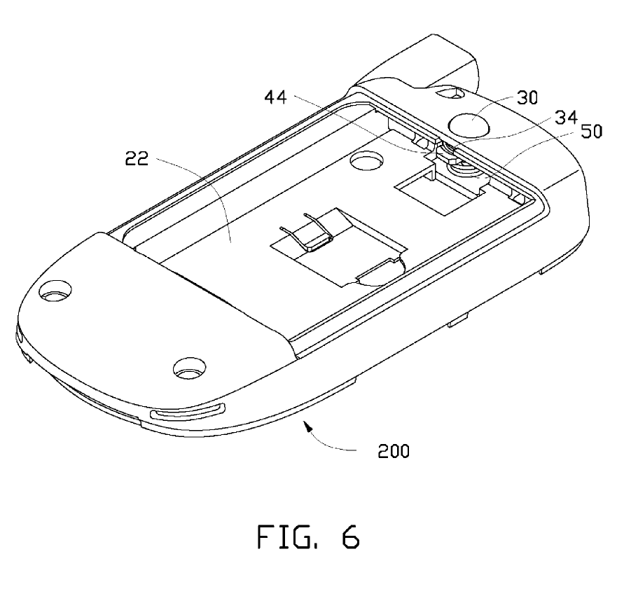

Also referring to FIGS. 5-6, the battery cover latching assembly 300 is configured to be received in the knob hole 26 of the housing 200. The battery cover latching assembly 300 includes a cap 30, a knob 40, a resilient member 50, a base 62, and a screw rod 64.

The cap 30 is a substantially hollow cylinder and has a closed end and an open end. A circular brim 34 is formed at the open end. The circular brim 34 defines two cutouts 342 therein. The two cutouts 342 are spaced from each other by an angle of about 180 degrees and are configured for receiving the projections 264 of the housing 200.

The knob 40 is a substantially hollow cylinder and has a screw hole 46 defined therethrough. One end of the knob 40 is configured for being received in the cap 30. A ring 42 is formed on a periphery of the knob 40. When the knob 40 is partially received in the cap 30 the ring 42 abuts against the circular brim 34 of the cap 30. A latching member 44 is formed on the ring 42. One end of the latching member 44 has a second wedge-shaped surface 442. The second wedge-shaped surface 442 is configured for engaging with the first wedge-shaped surface 142 of the battery cover 100.

The resilient member 50 should preferably be made of metal and be spiral-shaped (i.e. a coil spring). The base 62 can be a substantially rectangular board in shape. The screw rod 64 can be cylindrical in shape and can have an outer screw formed on a periphery thereof. The screw rod 64 can be formed on the base 62.

In assembly, the screw rod 64 is provided on the base 62 and the resilient member 50 surrounds the screw rod 64. The knob 40 is threaded onto the screw rod 64. One end of the resilient member 50 resists the base 62. The other opposing end of the resilient member 50 resists the ring 42 of the knob 40. The cap 30 is mounted on the knob 40. Thus the battery cover latching assembly 300 is assembled, as shown in FIG. 5. The assembled battery cover latching assembly 300 is inserted into the knob hole 26 of the housing 200. Each projection 264 of the housing 200 is received in one corresponding cutout 342 of the cap 30. The closed end of the cap 30 is exposed through the knob hole 26. The circuit board 700 is mounted in the receiving cavity 24 of the housing 200 and the base 62 is mounted to the circuit board 700. The latching member 44 extends into the battery cavity 22 and resists a limiting pole 266. The resilient member 50 is slightly compressed. Thus, the battery cover latching assembly 300 is assembled in the housing 200 and is rotatable about an axis of the screw rod 64, as shown in FIG. 6.

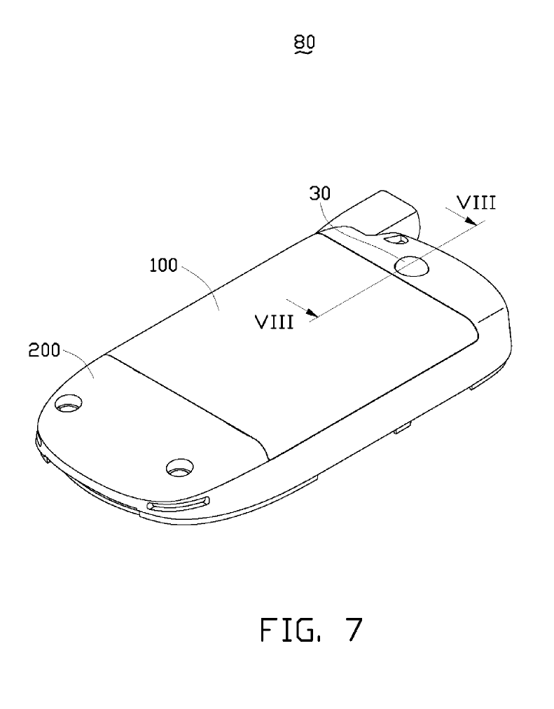

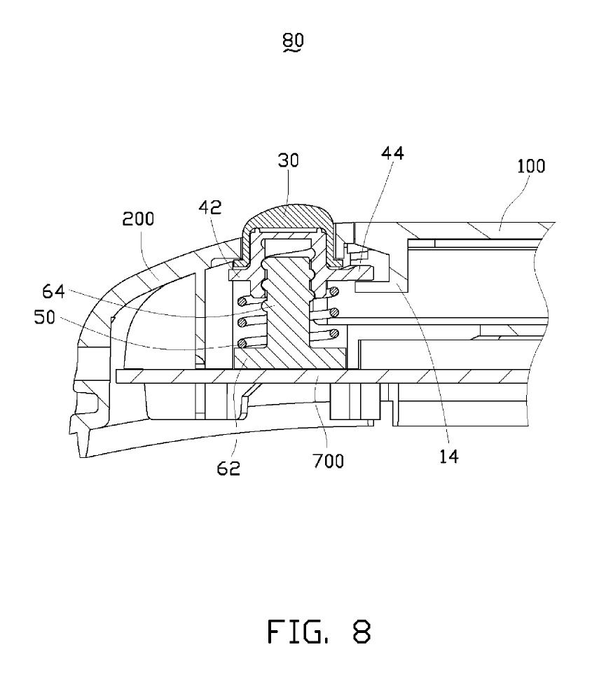

When the battery cover 100 is assembled to the housing 200, the positioning tabs 12 at one end of the battery cover 100 are received in the positioning holes of the housing 200. The opposite end of the battery cover 100 is pressed down onto the housing 200. When the positioning member 14 touches the latching member 44 of the knob 40, an external force along the axis of the screw rod 64 is applied on the cap 30. Then the knob 40 is moved along the axis of the screw rod 64 toward the base 62 and is rotated about the axis of the screw rod 64 with the engagement of the knob 40 and the screw rod 64. In this process the resilient member 50 is compressed and the latching member 44 is moved with the knob 40 and away from the positioning member 14 and the limiting pole 266 towards the other limiting pole 266. When the latching member 44 reaches the other limiting pole 266, the cap 30 can not be pressed further. When the battery cover 100 is fully closed, the cap 30 is released. Then the knob 40 is moved away from the base 62 and is rotated back to the original position due to the decompression force of the resilient member 50. The latching member 44 is rotated back and is received in the opening of the positioning member 14 with the first wedge-shaped surface 142 engaging with the second wedge-shaped surface 442. Thus, the battery cover 100 is assembled with the housing 200, as represented in FIGS. 7-8.

When the battery cover 100 is to be detached from the housing 200, the cap 30 is manually pressed downwards. Then the knob 40 is moved along the axis of the screw rod 64 toward the base 62 and is rotated about the axis of the screw rod 64 with the engagement of the knob 40 and the screw rod 64. In this process the resilient member 202 is compressed and the latching member is moved with the knob 40 and out from the engagement with the positioning member 14. The battery cover 100 is pulled away from the housing 200 manually. Then the cap 30 is released and the knob 40 is moved away from the base 62 and is rotated back to the original position due to the decompression force of the resilient member 50.

It is to be understood that the number of the positioning tabs 12 may be one or more than two. Accordingly, the number of the positioning holes for receiving the positioning tabs 12 may be one or more than two. The resilient member 50 may alternatively have a different configuration, for example, a leaf spring or a resilient cylinder.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching assembly for use in a portable electronic device, the portable electronic device having a battery cover and a housing connected via the battery cover latching assembly, the battery cover having a positioning member with a first wedge-shaped surface, the housing having a knob hole, and the battery cover latching assembly comprising a knob, the knob having a latching member with a second wedge-shaped surface, the knob being rotatably received in the knob hole of the housing and the first wedge-shaped surface being releasably engaged with the second wedge-shaped surface thereby allowing the battery cover latching assembly to releasably mount the battery cover to the housing.

2. The battery cover latching assembly as claimed in claim 1, further including a screw rod, wherein the screw rod is formed on the housing and the knob is threaded onto the screw rod.

3. The battery cover latching assembly as claimed in claim 2, wherein the battery cover latching assembly further includes a base, the screw rod is formed on the base, and the base is formed on the housing.

4. The battery cover latching assembly as claimed in claim 1, wherein the battery cover latching assembly further includes a resilient member and the resilient member is disposed between the knob and the housing.

5. The battery cover latching assembly as claimed in claim 4, wherein the resilient member is substantially cylindrical in form and is located parallel to a rotatable axis of the knob.

6. A portable electronic device comprising:
a battery cover having a positioning member;
a housing having a knob hole, and
a battery cover latching assembly releasably connecting the battery cover and the housing,
where the battery cover latching assembly comprises a knob having a latching member, the knob being rotatably received in the knob hole about an axis;
wherein, if an external force is applied on the knob along the axis, the knob rotates about the axis enabling the latching member to be releasably engaged with the positioning member thereby releasably mounting the battery cover to the housing.

7. The battery cover latching assembly as claimed in claim 6, wherein the battery cover latching assembly further includes a screw rod, the screw rod is formed on the housing, and the knob is threadingly engaged with the screw rod.

8. The battery cover latching assembly as claimed in claim 6, wherein the battery cover latching assembly further includes a resilient member and the resilient member is disposed between the knob and the housing.

9. The battery cover latching assembly as claimed in claim 8, wherein the resilient member is substantially in a form of a cylinder and is located parallel to the axis of the knob.

10. The battery cover latching assembly as claimed in claim 6, wherein one of the battery cover and the housing forms a positioning tab, the other of the battery cover and the housing defines a positioning hole, and the positioning tab is configured for being received in the positioning hole.

11. The battery cover latching assembly as claimed in claim 6, wherein a ring is formed around the latching member, one end of the knob is exposed through the knob hole of the housing, and the ring abuts the housing.

12. The battery cover latching assembly as claimed in claim 6, wherein two limiting poles are formed on the housing near the knob hole and the limiting poles are spaced apart from each other.

13. The battery cover latching assembly as claimed in claim 6, wherein the battery cover latching assembly further includes a cap, the cap is provided on one end of the knob, and the cap is exposed through the knob hole of the housing.

14. The battery cover latching assembly as claimed in claim 6, wherein the positioning member is substantially C-shaped and has a wedge-shaped surface.

15. The battery cover latching assembly as claimed in claim 14, wherein the latching member has a wedge-shaped surface engaging with the wedge-shaped surface of the positioning member.

16. A portable electronic device comprising:
a battery cover having a positioning member;
a housing having a knob hole, and
a battery cover latching assembly releasably connecting the battery cover and the housing, and the battery cover latching assembly comprising:
a knob having a latching member, the knob being rotatably received in the knob hole; and
a screw rod formed on the housing, the knob threadingly engaging with the screw rod and the latching member releasably engaging with the positioning member thereby the battery cover latching assembly releasably mounting the battery cover to the housing.

17. The battery cover latching assembly as claimed in claim 16, wherein the battery cover latching assembly further includes a resilient member and the resilient member surrounds the screw rod and is disposed between the knob and the housing.

18. The battery cover latching assembly as claimed in claim 16, wherein two limiting poles are formed on the housing near the knob hole and the limiting poles are spaced apart from each other.

19. The battery cover latching assembly as claimed in claim 16, wherein the positioning member is substantially C-shaped and has a wedge-shaped surface, and the latching member has a wedge-shaped surface engaging with the wedge-shaped surface of the positioning member.
